(19) United States
(12) Patent Application Publication
(10) Pub. No.: US 2024/0157535 A1
(43) Pub. Date: May 16, 2024

(54) Rechargeable Battery Device of Cordless Power Tool

(71) Applicant: Solomon Chang, Taipei City (TW)

(72) Inventor: Solomon Chang, Taipei City (TW)

(21) Appl. No.: 17/986,910

(22) Filed: Nov. 15, 2022

(51) Int. Cl. B25F 5/00

(52) U.S. Cl. CPC B25F 5/00

(57) ABSTRACT

The present invention relates to a rechargeable battery device of a cordless power tool. The rechargeable battery device provides a power source for a cordless power tool. It is mainly based on the original one, and the Universal Serial Bus (USB) specification of the power transmission connection port is added as a connection interface, so that the rechargeable battery device can be used as a portable charging device (power bank). Since the connectors and wires of the USB standard have been widely used, easy to obtain and have high versatility, the environmental burden can be greatly reduced, and the application and practicability of the rechargeable battery device can be improved.

### BACKGROUND OF THE PRESENT INVENTION

### Field of Invention

The present invention relates to a rechargeable battery device of a cordless power tool, which has a connection port arranged thereon for power transmission, whereby the rechargeable battery device of the cordless power tool can be used as a portable charging device (power bank) for charging other devices, so as to improve the application and practicality of the rechargeable battery device.

### Description of Related Arts

It is noted that the wireless power tools on the market are commonly hand-held power tools to perform operations such as locking, drilling, cutting or grinding, which provide great practicability and convenience. This type of wireless power tools all utilize replaceable rechargeable battery devices to supply the electrical energy required by the power tools. When the electric power of the rechargeable battery device is exhausted, another rechargeable battery device with full electric energy can be replaced immediately, and the user usually purchases multiple rechargeable battery devices to meet the electric power required for the operation according to the needs of the operation.

Hence, the inventor, adhering to the rich experience in designing and development and actual production for many years in the related industries, studies and improves the conventional structure and deficiencies.

In the above-mentioned rechargeable battery device, a commonly used connection port is added as a connection interface for power transmission, in order to achieve better practicability and application.

### SUMMARY OF THE PRESENT INVENTION

A main object of the present invention is to provide a rechargeable battery device of cordless power tool, wherein the rechargeable battery device has a widely used Universal Serial Bus (hereinafter referred to as USB) specification connection port as a power transmission connector, wherein the connector can use a Universal Serial Bus Type-C connector (referred to as USB-C), or a widely used Universal Serial Bus Type-A connector (referred to as USB-A). Since USB connectors have been widely used, if the power delivery protocol interface (Power Deliver, referred to as PD) of USB-C is used, it can be upgraded to adapt 20V/5 A or 100 W or even a larger power. Nevertheless, the multiple connection interfaces can be adapted for the connection of different connection cables, so that the rechargeable battery device can be used as a portable charging device (power bank).

The rechargeable battery device has a connector interface disposed thereon and can be used as a portable charging device to supply charging for other electronic devices (such as mobile phones, tablet computers or laptop computers). It is believed that in the future, tablet computers and laptop computers will be improved in terms of computing processing or network transmission speed, so that the power consumption will gradually increase, resulting in a higher demand for power transmission and capacity. Therefore, the present invention allows regular rechargeable battery device of power tool to become capable of satisfying the charging requirements of other devices, thereby greatly improving the application and practicability of the rechargeable battery device.

The main objects and effects of the rechargeable battery device of the cordless power tool of the present invention are achieved through the following specific technical means.

### BRIEF DESCRIPTION OF THE DRAWINGS

FIG. 1 is an exploded view of the present invention.

FIG. 2 is a perspective view of the internal of a rechargeable battery device according to the present invention.

FIG. 3 is another perspective view of the internal of the rechargeable battery device according to the present invention.

FIG. 4 is a perspective view of the use state of the rechargeable battery device according to the present invention.

### DETAILED DESCRIPTION OF THE PREFERRED EMBODIMENT

The technical content, the object of the creation and the effect achieved by the present invention are more completely and clearly disclosed, which are described in detail below, and referring to the disclosed drawings and drawing numbers:

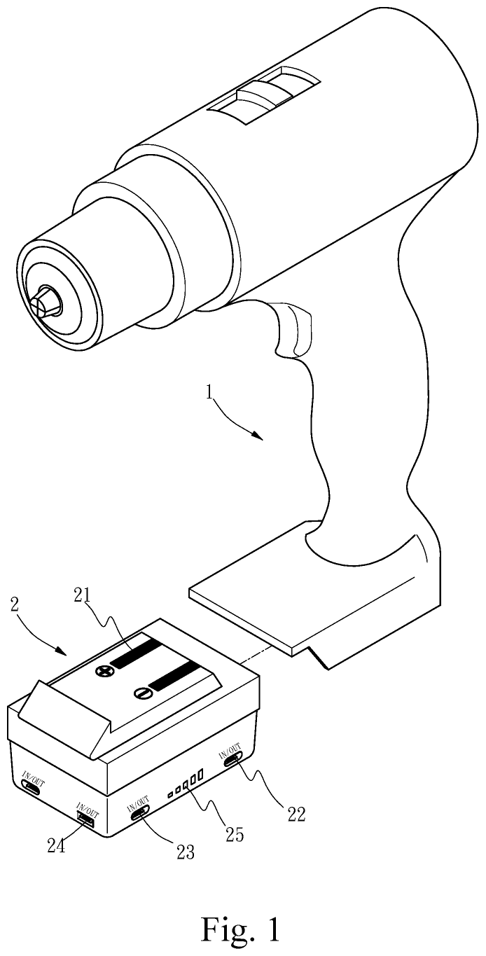

First, referring to FIG. 1 is an exploded view of the present invention, the present invention refers to a rechargeable battery device 2 of a cordless power tool 1, wherein the rechargeable battery device 2 mainly provides the power source for the cordless power tool 1, so that the cordless power tool 1 does not need to be tethered by a power cord, so as to be convenient to carry and not be restricted by the condition of whether there is a power supply on site. Here, the rechargeable battery device 2 includes positive and negative connection terminals 21 disposed on the top thereof, so as to supply the electric power required for the operation of the cordless power tool 1.

Next, the rechargeable battery device 2 of the present invention includes a current transmission connector 22, 23 respectively disposed on one side thereof, wherein the power transmission connectors 22 and 23 are USB Type-C connectors that are widely used today, so that the charging operation is no longer restricted to merely use certain specific chargers. Since the USB Type-C connector does not have a fool-proof structure for a specific insertion direction and has a high-power current transmission, it is most suitable as an interface for power transmission. In particular, if the power output and input specifications are adopted through the Power Delivery (PD) protocol, it will be able to provide higher power transmission speed.

Besides, the rechargeable battery device 2 further includes a power transmission connector 24 disposed on the other side thereof, wherein the power transmission connector 24 is another widely used USB Type-A connector. Although the power transfer efficiency of the USB Type-A is not as good as that of the USB Type-C, it is one of the most widely used connector specifications, so that the device can satisfy both old and new connector specifications that are different, so as to improve the practicability of the rechargeable battery device 2.

Finally, the rechargeable battery device 2 also includes a power indicator light disposed on one side thereof to display the remaining capacity of the rechargeable battery device 2, so as to allow the user to evaluate whether it is charged or not.

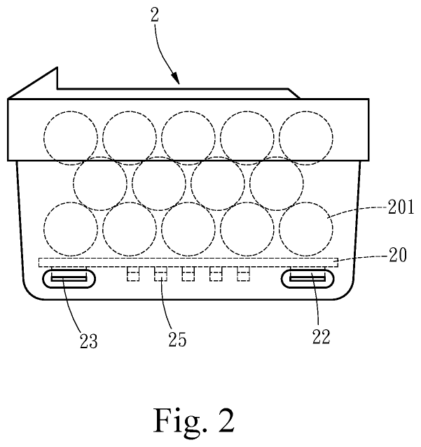

Further, referring to FIG. 2, it is a perspective view of the internal of the rechargeable battery device of the present invention, wherein the rechargeable battery device 2 includes a circuit board 20 as a carrier disposed inside thereof. The circuit board includes a plurality of cylindrical batteries 201 arranged at one end thereof, while the power transmission connectors 22, 23 and a power indicator light 25 are arranged at the other end respectively, wherein the cylindrical batteries 201 can be arranged and combined in series or parallel according to the electric power required by the power tool.

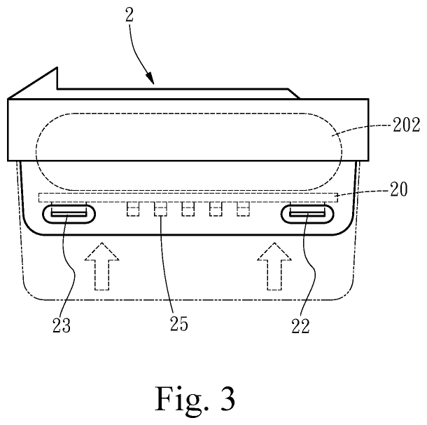

Referring to FIG. 3, it is another internal perspective view of the rechargeable battery device of the present invention, wherein the rechargeable battery device 2 includes a circuit board 20 as a carrier disposed inside thereof. The circuit board 20 includes power transmission connectors 22 and 23 and a power indicator light 25 respectively disposed at one end thereof, and a battery pack 202 is disposed at the other end thereof.

With respect to the cylindrical battery 201 in FIG. 2, the battery pack 202 can be made into batteries of various shapes and capacities according to the needs of the power tool, which can also greatly reduce the volume of the rechargeable battery device 2.

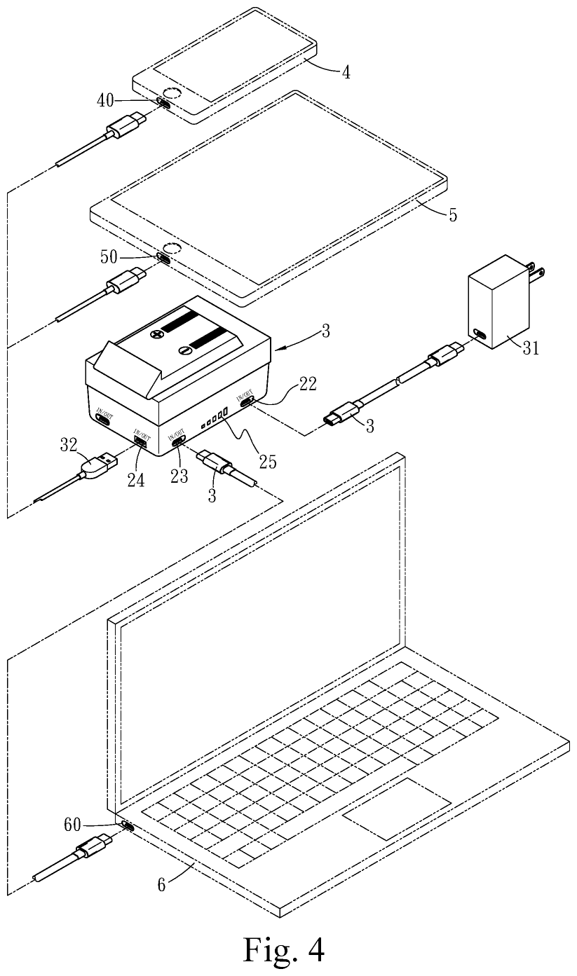

Referring to FIG. 4, it is a perspective view of the use state of the rechargeable battery device of the present invention, the power transmission connector 22 of the rechargeable battery device 2 can be used to connect the same USB Type C connecting line 3 to the charging plug 31, and then use the AC power source as an input charging source.

The power transmission connector 23 is connected with the connecting port 60 of the notebook computer 6 through the connecting line 3, and is used as a power output for charging. Since the notebook computer 6 requires high power, the connecting line 3 and the connector 23 are both USB Type-C and adopt the Power Delivery (PD) protocol to provide a more efficient power supply.

In addition, the power transmission connector 24 is another widely used USB Type-A connector. Although its power transmission efficiency is not as good as that of the USB Type-C, it is enough to provide charging of power output for devices with less power. As shown in the figure, the connecting line 3 and the power transmission connector 24 are both USB Type-A, and after connection, the power can be output to the connecting port 40 of the mobile phone 4 or the connecting port 50 of the tablet computer 5, so as to meet the use of connectors of different specifications and improve the practicability.

In summary, the embodiments or drawings shall not limit the implementations of the present invention, and any appropriate changes or modifications made by those with ordinary knowledge in the technical field shall be regarded as not departing from the patent scope of the present invention.

What is claimed is:

1. A rechargeable battery device of a cordless power tool, comprising: a circuit board as a carrier disposed inside thereof, wherein said circuit board has a rechargeable battery arranged at an upper end thereof, and a power indicator light and a power transmission connection port arranged at a lower end thereof respectively,
wherein said power transmission connection port adaptes a Universal Serial Bus (USB) connector as the connection interface, so that said rechargeable battery device is allowed to be used as a portable charging device (power bank), which improves the application and practicability of said rechargeable battery device.

2. The rechargeable battery device of the cordless power tool, as recited in claim 1, wherein one of said connection ports allows a Universal Serial Bus Type-C (USB-C) connector to provide a variety of connection interfaces and increase the practicability of charging connections for different devices.

3. The rechargeable battery device of the cordless power tool, as recited in claim 1, wherein one of said connection ports allows a Universal Serial Bus Type-A (USB-A) connector to provide a variety of connection interfaces and increase the practicability of charging connections for different devices.

4. The rechargeable battery device of the cordless power tool, as recited in claim 1, wherein said rechargeable battery is implemented as one or more cylindrical battery arranged in series or parallel according to the required power.
